(19) United States
(12) Patent Application Publication
(10) Pub. No.: US 2013/0007769 A1
(43) Pub. Date: Jan. 3, 2013

(54) Tracking File-Centric Events

(75) Inventors: Christopher S. Alkov, Austin, TX (US); Travis M. Grigsby, Austin, TX (US); Andrew J. Ivory, Wake Forest, NC (US); Trevor Livingston, Austin, TX (US)

(73) Assignee: INTERNATIONAL BUSINESS MACHINES CORPORATION, Armonk, NY (US)

(21) Appl. No.: 13/171,451

(22) Filed: Jun. 29, 2011

(51) Int. Cl. G06F 9/44

(52) U.S. Cl. 719/318

(57) ABSTRACT

File-centric events are tracked and recorded in a system-wide event log. Preferably, the tracking is controlled by the operating system, and applies to all executing applications. Various types of information may be recorded for a particular event, and this information may vary depending on the application to which the event pertains and/or on the type of event. Event information for a particular file can be retrieved upon request, and may be displayed to a user.

### CROSS-REFERENCE TO RELATED APPLICATION

The present invention is related to commonly-assigned and co-pending application Ser. No. ______, which is titled “DISCOVERING RELATED FILES AND PROVIDING DIFFERENTIATING INFORMATION” (Attorney Docket RSW920110032US1). This application, which is referred to hereinafter as “the related application”, was filed on even date herewith and is incorporated herein by reference.

### BACKGROUND

The present invention relates to computing systems, and deals more particularly with techniques for tracking file-centric events by an operating system. The events may be displayed to a user.

A user of a computing device (such as a laptop computer, desktop computer, handheld computer, etc.) may have a very large number of files stored on the computing device or accessible thereto. Managing these files can therefore be problematic.

### BRIEF SUMMARY

The present invention is directed to file-centric tracking of events. In one aspect, this comprises: invoking event tracking by an operating system of a computer at system start-up, the event tracking pertaining to events performed for files by applications executing on the computer; responsive to occurrence of an event for a file, tracking the event by recording an event record in an event log for the computer, the event record comprising an identifier of the file, an identifier of the event, and an identifier of an application performing the event for the file; and responsive to a request from a user to view events for the file, retrieving the event record and displaying the retrieved event record for the user. The occurrence of the event may be detected by the operating system when the application obtains a lock on the file or when the application releases the lock on the file. An application programming interface (“API”) for the event tracking may be accessible to the applications executing on the computer, and the occurrence of the event may be detected by the operating system when the application invokes the API.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIGS. 1, 3, and 5 provide flowcharts depicting logic which may be used when implementing embodiments of the present invention;

FIG. 2 illustrates a sample structure for a record in an event log;

FIG. 4 (comprising FIGS. 4A-4F) provides sample graphical interface depictions, showing how a user may interact with an embodiment of the present invention;

FIG. 6 depicts a data processing system suitable for storing and/or executing program code; and

FIG. 7 depicts a representative networking environment in which one or more embodiments of the present invention may be used.

### DETAILED DESCRIPTION

A user of a computing device may have a very large number of files stored on the computing device or accessible thereto. It becomes difficult to manage the files, particularly in view of a user's ability to remember what events pertain to a particular file. Accordingly, it is desirable to provide an automated way for a user to obtain event information pertaining to one or more files. In preferred embodiments, event information is tracked for each file, and information for a file of interest can then be retrieved. The retrieved information may be provided to a user on a graphical user interface of a computing device.

For example, a user might need to send a report to his manager by e-mail, but is not able to remember whether he has actually sent the report. Using conventional techniques, the user has to open his e-mail application and then manually peruse his already-sent messages to see if he sent an e-mail message to his manager, and if that e-mail message had the report attached. If the user has a number of e-mail folders, it may be time-consuming to check through multiple folders looking for such e-mail message. And, if the user has deleted this particular message from his computing device, then he will not find a record of sending the report even after perusing all of the e-mail folders. Using an embodiment of the present invention, by contrast, this information is available for automated recall, and can be presented to the user on the graphical interface of the user's computing device. Further events details may be provided, including (for the e-mail sending example) the date and time when the e-mail message was sent, the e-mail subject line, the e-mail address of the target recipient, and/or a list of attachments to the e-mail message.

A preferred embodiment retains event information for files that are deleted, including a record of the deletion event. Accordingly, the user can determine whether he sent the report to his manager by e-mail even though he may have already deleted an e-mail message to which the report was attached. In a more general case, a user of an embodiment of the present invention is able to view not only conventional properties for a file, but also information regarding what has been done to the file, where it came from, and so forth.

Some files may be related to each other. The user may want to see event information for a collection of related files. Files may be related according to different criteria. In one example, a user may have many versions (also referred to herein as “copies”) of a particular file, and the versions may therefore be considered as related to one another. As another example of file relatedness, it may be useful to consider files that were opened, closed, or modified at the same time—or at nearly the same time—as being related to one another. As yet another example of file relatedness, it may be useful to consider files having similar content as being related. These examples are by way of illustration but not of limitation, and relatedness may be determined using other criteria without deviating from the scope of the present invention. Refer to the related invention for a more detailed discussion of file relatedness.

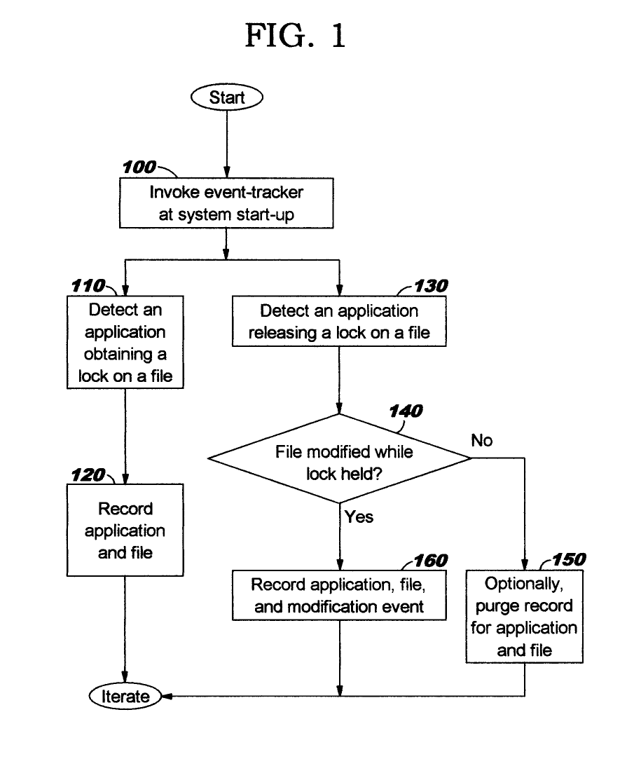

Referring now to FIG. 1, a flowchart is provided that depicts logic which may be used when implementing an embodiment of the present invention. Preferably, the file-centric tracking is coordinated by the operating system executing on a computing device (for example, to ensure that the event-tracking information is captured for all applications in a consistent manner), and the processing shown in FIG. 1 may therefore be carried out by the operating system. As shown therein at Block 100, an event-tracker function as disclosed herein is invoked at system start-up. In one approach, this event tracker is triggered by file locking operations. Accordingly, when an executing application obtains a lock on a file, this is detected at Block 110. As is known in the art, a “lock held” status for a particular file is available within a computing system so that other applications are aware of this status and do not try to modify a file held by another application. Responsive to determining that the application obtains the lock, Block 120 creates a record comprising an identifier of the application and of the file which is now locked. This identifying information preferably comprises at least the application name and the file name. When a lock is obtained upon opening a file, the processing of Blocks 110-120 preferably comprises recording a “file open” event in an event log. Following the recording at Block 120, the processing of this lock obtained event ends (and additional events are iteratively processed by re-executing the logic that begins at Block 110).

The processing of Block 110 and 120 may be invoked for a number of different applications and a number of different files. At some point, Block 130 detects that one of these applications releases the lock it is holding on one of these files. (That is, while looping and waiting has not been illustrated in FIG. 1 for drafting convenience, it will be obvious to one of ordinary skill in the art that the application and file referred to by Block 130 are not necessarily the same as those referenced in Blocks 110 and 120.)

Block 140 then tests whether the application releasing the lock modified the locked file. This may be determined, for example, by checking a timestamp on the file to determine whether it represents a time close to the current system time, indicating that this copy of the file is new or newly modified. In another approach, the recording at Block 120 may include additional information about the file being locked, beyond the fact that the file was locked. Such additional information may comprise, by way of example, a then-current timestamp, a size of the file, a hash of the file contents, and/or additional attribute information describing the file in its then-current state. The processing at Block 140 may then comprise comparing this previously-recorded information to now-current information for the file to determine whether the file has been modified.

When the test at Block 140 has a negative result, the information recorded at Block 120 when the lock was obtained may optionally be purged, as indicated at Block 150. In this scenario, an embodiment of the present invention captures file-changing events (and this particular file has not been changed). A data structure in which the operating system keeps track of which files are locked is preferably updated to record that this particular lock is no longer being held (i.e., this file is no longer locked). Accordingly, the purging at Block 150 may comprise removing a file-locked record created by executing Block 120.

Alternatively, the processing of Block 150 records an event in the event log to indicate that this particular file was used by this particular application, but was not modified. The recorded event information may comprise, by way of example, the application name and the file name, as well as an operation such as “file closed” and a date and time at which the close event occurred. Following the operation of Block 150, the processing of this lock release event ends.

An embodiment of the present invention may be adapted to include file locking operations in the events which are tracked. Accordingly, an event log record may be created for the file locking and lock release operations, and preferably contains the application name, the file name, and the lock event, and may also contain further event details such as the time of locking the file and the time of lock release. As one alternative, the locking event and the lock release event may be recorded as separate event records, in which case the record for the locking event is preferably created at Block 120.

When the test at Block 140 has a positive result, indicating that the application modified the file while it was locked, control reaches Block 160. An event is recorded to reflect that this particular file was modified by this particular application. In addition to the application name and file name, further event details such as the type of modification may also be recorded. The locking and the lock releasing may also be recorded as events, as discussed above with reference to Block 150. When Block 120 records additional then-current state information pertaining to a file being locked, as discussed above, the processing at Block 160 may further comprise recording now-current information for one or more of these same attributes of the file. The particular type of information recorded in an event log record may depend on the type of event that was performed. Following the operation of Block 160, the processing of this lock release event ends.

When file locking and lock-releasing information is recorded separately from other types of file-centric events, the lock information may be recorded in a repository accessible to the operating system. The other event information discussed above is preferably recorded, for all applications executing in a system controlled by the operating system, in a system-wide repository which is also referred to herein as an “event log”. Attributes that may be recorded in the system-wide repository include, by way of illustration but not of limitation, a file identifier such as the name of the file (and optionally, further information that may be needed to distinguish among multiple copies of the file); a timestamp of the file; an identifier (such as a name) of the event; an identifier (such as a name) of the application; and other file attributes. As an example of other file attributes, the repository may record information about related files. An identification of files that were opened at the same time, or nearly the same time, may be provided as the related files attribute, for example. Refer to the related application for a more detailed description of information that may be gathered for related files. Such information may then be recorded in the system-wide repository according to an embodiment of the present invention.

Several non-limiting examples of event information that may be logged in the event log include:

for a “rename” event: old file name

for a “move” event: reference to old location

for a “copy” event: reference to source file

for a “modify” event: reference to backup (e.g., unmodified) file

for related files: identifiers of the other files; optionally, an indication of the relatedness criteria (i.e., why the files are considered to be related, such as “opened concurrently”)

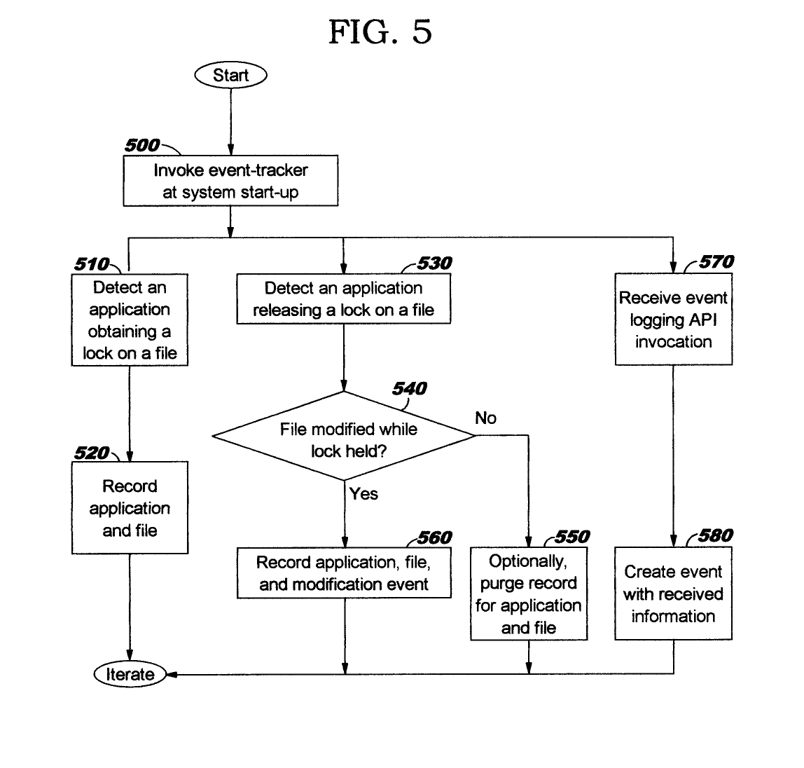

application-specific information: Refer to the discussion of FIG. 5, below.

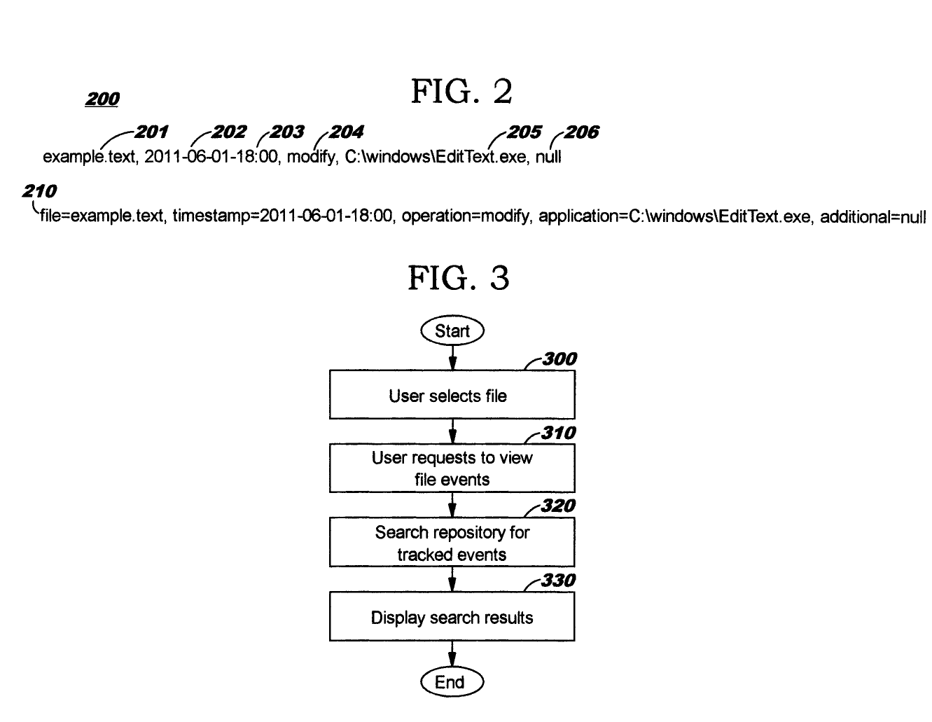

As one example of using the processing discussed above with reference to FIG. 1, suppose a user named “Allen” opens a file named “example.text” using an application named “EditText”, and then subsequently closes the file. A record indicating that the “EditText” application used the “example.text” file is therefore created at Block 160. One form in which this record may be created is shown at 200 in FIG. 2. In this example, the record comprises (by way of illustration only) the name of the file 201; a timestamp formed from the current date 202 and the current time 203; a name of the event that occurred for this file 204; the name of the application 205 that performed the event; and additional information 206 (which may comprise an identification of related files). A value of “null” is provided at 206, indicating that no additional information was recorded for this example. Another form in which this record may be created is shown at 210 in FIG. 2, using name/value pairs.

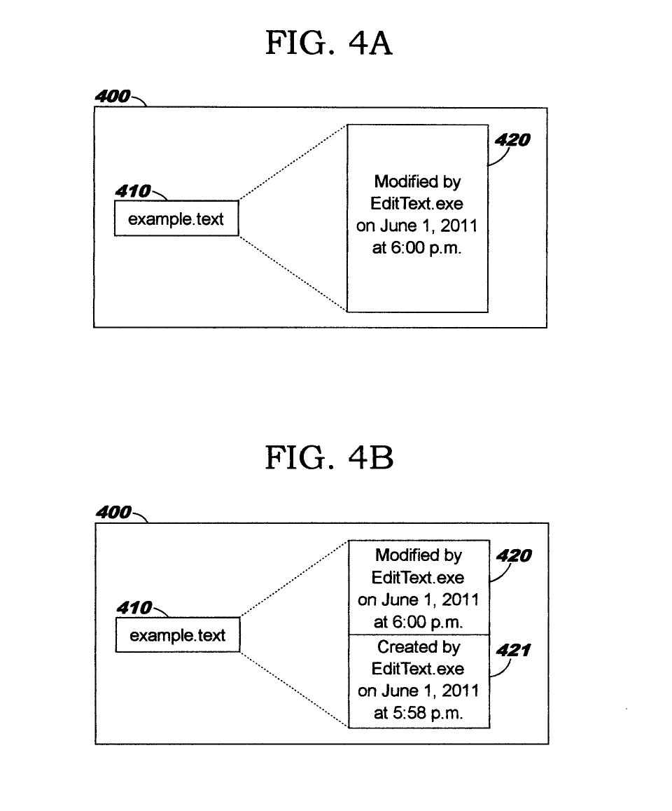

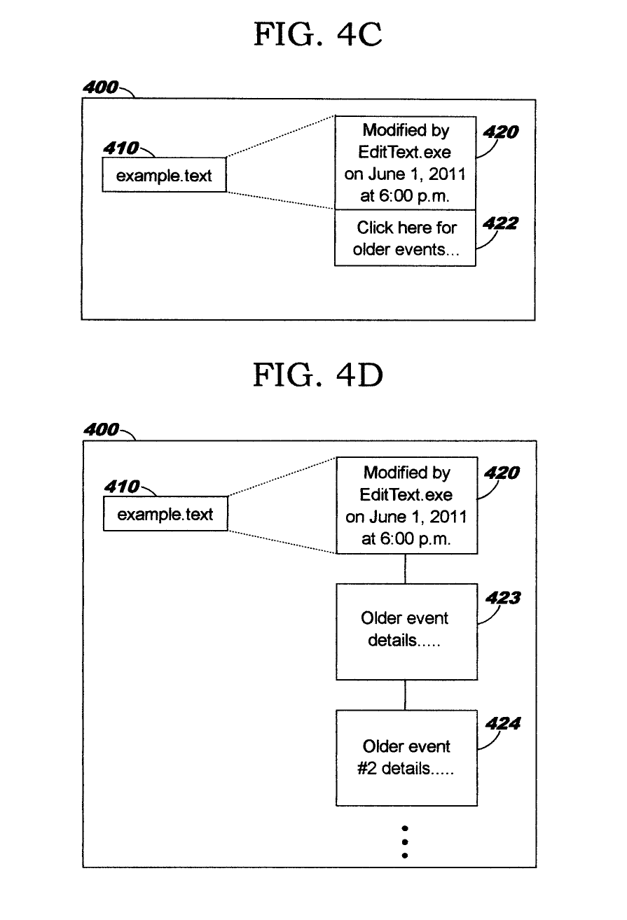

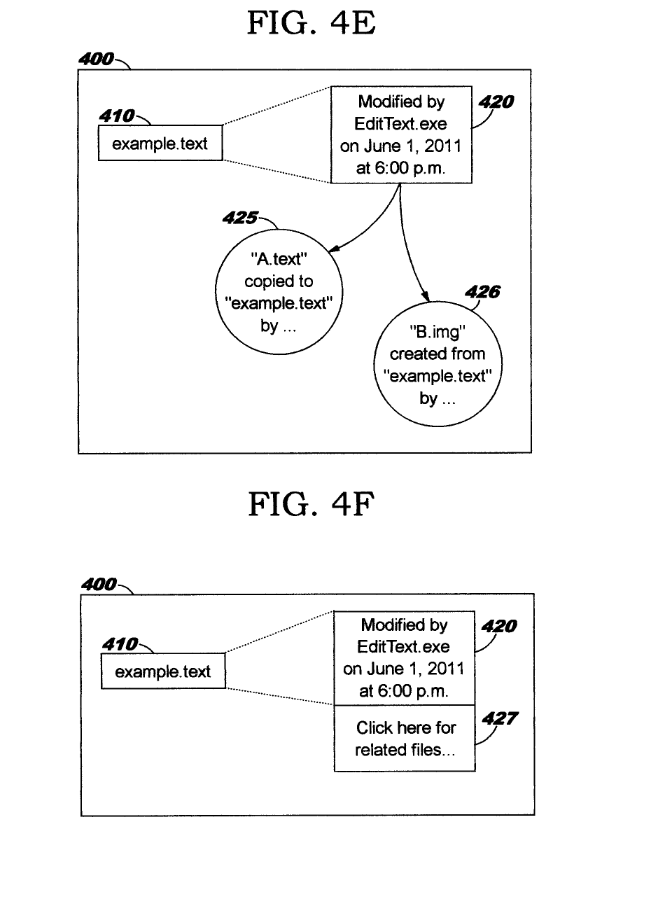

At some point, a user may request to view information about the events for a particular file. FIG. 3 provides a flowchart depicting logic which may be used for accepting and carrying out such request. As shown therein at Block 300, the user selects a file. An icon or other representation of the file may be provided on a graphical user interface, as illustrated by icon 410 on user interface 400 of FIG. 4A, and the selecting at Block 300 may comprise (by way of example) activating a button of a mouse pointer positioned over such icon. At Block 310, the user then requests to view file events for the selected file. This may comprise (by way of example) the user right-clicking with the mouse to cause a pop-up selection menu to be presented, which in turn provides a selection such as “View File Events” that is then selected by the user. As will be obvious, the request to view file events may be triggered in other ways without deviating from the scope of the present invention.

Block 320 then searches the system-wide repository for one or more events pertaining to the selected file, and at Block 330, the search results are presented to the user. With reference to the above-described scenario, the file selected using icon 410 is “example.text”, and Block 320 locates the recorded event 200. Information describing this event is shown to the user at 420 in FIG. 4A.

A number of event display techniques may be used without deviating from the scope of the present invention. For example, in one approach, only the most-recent event is displayed responsive to the user's initial request, as has been shown in FIG. 4A. Optionally, additional events can be retrieved from the repository and displayed as well. In one approach, these additional events obtained responsive to the user's initial request at Block 310. In another approach, the processing of Block 310 obtains the most-recent event, and another user action may be invoked to request additional events.

When additional events are shown for a particular file, they may be depicted using the same level of detail used for the most-recent event. This is shown in FIG. 4B, where an additional event 421 is depicted (and in this example, this additional event corresponds to creation of the “example.text” file).

As one alternative, a condensed representation of the additional events may be displayed, where further details are selectively provided to the user responsive to a request for such details. This is illustrated in FIG. 4C, where a selectable link with text such as “Click here for older events . . . ” is provided as shown at 422. In response to selecting this link, information for additional events may then be presented, as shown in an abstract manner at 423, 424 in FIG. 4D.

When information for related files is available in one or more entries of the event log (as discussed above with reference to 206 of FIG. 2, for example), this related file information may be shown in a number of different ways. FIG. 4E illustrates one manner of displaying related file information, where—in this example—related event information for two files that are related to file 410. See reference numbers 425, 426. In one approach, the related file information is presented with the initial display of file event information, responsive to the user right-clicking on (or otherwise selecting to view file events for) the file as illustrated in FIG. 4A. In another approach, a selectable link with text such as “Click here for related files . . . ” may be presented, as shown at 427 in FIG. 4F. The information illustrated at 425, 426 of FIG. 4E may then be presented responsive to the user selecting this link 427.

Referring now to FIG. 5, a flowchart is provided that depicts logic which may be used when implementing an embodiment of the present invention. In this embodiment, applications are allowed to write application-specific entries to the event log. An event-tracker function provided by the operating system may provide an application programming interface, or “API”, that is usable by the applications for this purpose.

Blocks 500 through 560 preferably operate as has been discussed above with reference to Blocks 100-160 of FIG. 1. That is, the operating system invokes an event-tracker function at system start-up (Block 500) to provide file-centric tracking, and the operating system is aware of applications obtaining locks (Block 510) and releasing these locks (Block 530), and event information is preferably handled as described with reference to FIG. 1. FIG. 5 illustrates the operating system also receiving application-specific event input from executing applications. See Block 570, which represents the event-tracker API being invoked by an application to supply event information for a particular event as detected by the application, and Block 580, where an event log record is created to record this information along with information recorded in the system-wide repository by Block 560 (and optionally by Blocks 520 and/or 550; refer to the discussion of corresponding Blocks 120 and 150, above).

In addition to the examples of logged event information discussed earlier, several non-limiting examples of application-specific event information that may be logged include:

from an e-mail application:
file “X” was attached to an e-mail message sent to user “Bob”
file “X” was attached to an e-mail message sent to user “Bob”, and files “Y” and “Z” were also attached to the e-mail message
file “X” was attached to an e-mail message sent to user “Bob”, and a link to the e-mail message may be provided in the log

from a photo-editing application:
filter “Remove Red-Eye” was applied to the image in file “C”
filter “Rotate Clockwise” was applied to the image in file “D”
filter “Remove Red-Eye” was applied to the image in file “C”, followed by filter “Crop Image”

from a browser application:
file “D” was uploaded to web site “www.ibm.com”

When application-specific information is recorded in the event log, an embodiment of the present invention may display this application-specific information to a user in an actionable manner (e.g., using a clickable link). For event information indicating that a user-selected file (e.g., a file selected in the manner discussed above with reference to 410 in FIG. 4A) was attached to an e-mail message, for example, a selectable link may be provided on the graphical interface whereby the user can click on this link to automatically open the e-mail message in an e-mail application window. For event information indicating that a user-selected file was opened in a photo editor and then filtered, the application-provided event information may be used to construct a “before and after” display showing (for example) the original image and the resulting image. Optionally, interim views may also be provided when multiple filters have been applied. For example, the photo editing application may be opened responsive to selecting the event link, causing the photo editing application to play a slide show of images, each corresponding to a result of applying one such filter. For event information indicating that a user-selected file was uploaded using a browser application, the selectable link may open the browser and display the uploaded file therein. A number of other scenarios will be envisaged in view of the disclosure provided herein.

Various data compression techniques may be used with an embodiment of the present invention to compact the size of the system-wide event log. Preferably, database normalization techniques are used, such as providing an identifier or pointer that links to a value that occurs repeatedly rather than storing the entire value multiple times. A separate database table might therefore be created that associates file names with shorter file identifiers, or that associates file operations with a corresponding integer value, and so forth.

Applications are known that provide application-specific metadata for files operated on by the application. One example is the well-known Photoshop® application, which stores various metadata inside files it creates. (“Photoshop” is a registered trademark of Adobe Systems Incorporated in the United States, other countries, or both.) An event-logging service of the Windows® operating system is known, which can be optionally activated to track user actions and system resource usage events with a number of event logs. (“Windows” is a registered trademark of Microsoft Corporation in the United States, other countries or both.) However, the present inventors are not aware of a technique that is applied to all executing applications in a universal way to track file-centric events for all files in the manner which has been discussed above.

As has been demonstrated, an embodiment of the present invention assists a user by tracking file-centric events and then retrieving and displaying events pertaining to a particular user-selected file. While embodiments have been described herein with reference to a visual display of event information, this is by way of illustration and not of limitation.

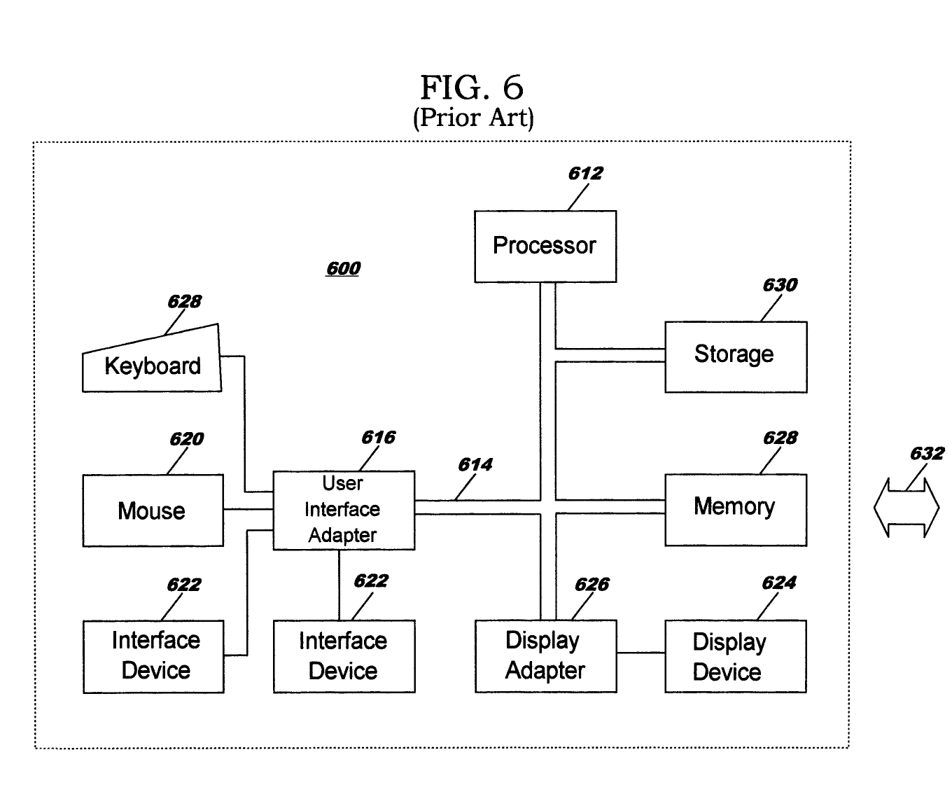

Referring now to FIG. 6, a data processing system 600 suitable for storing and/or executing program code includes at least one processor 612 coupled directly or indirectly to memory elements through a system bus 614. The memory elements can include local memory 628 employed during actual execution of the program code, bulk storage 630, and cache memories (not shown) which provide temporary storage of at least some program code in order to reduce the number of times code must be retrieved from bulk storage during execution.

Input/output (“I/O”) devices (including but not limited to keyboards 618, displays 624, pointing devices 620, other interface devices 622, etc.) can be coupled to the system either directly or through intervening I/O controllers or adapters (616, 626).

Network adapters may also be coupled to the system to enable the data processing system to become coupled to other data processing systems or remote printers or storage devices through intervening private or public networks (as shown generally at 632). Modems, cable modem attachments, wireless adapters, and Ethernet cards are just a few of the currently-available types of network adapters.

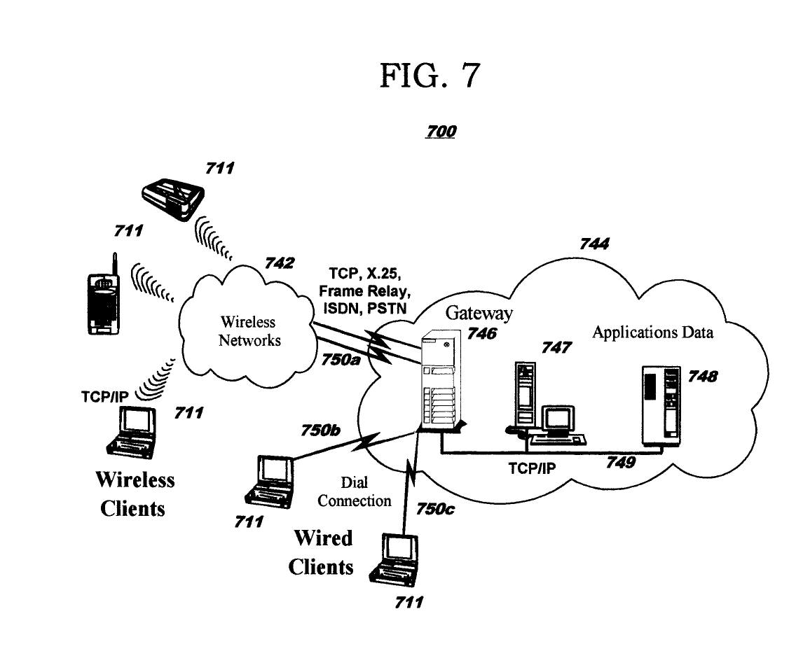

FIG. 7 illustrates a data processing network environment 700 in which the present invention may be practiced. The data processing network 700 may include a plurality of individual networks, such as wireless network 742 and wired network 744. A plurality of wireless devices 710 may communicate over wireless network 742, and a plurality of wired devices, shown in the figure (by way of illustration) as workstations 711, may communicate over network 744. Additionally, as those skilled in the art will appreciate, one or more local area networks (“LANs”) may be included (not shown), where a LAN may comprise a plurality of devices coupled to a host processor.

Still referring to FIG. 7, the networks 742 and 744 may also include mainframe computers or servers, such as a gateway computer 746 or application server 747 (which may access a data repository 748). A gateway computer 746 serves as a point of entry into each network, such as network 744. The gateway 746 may be preferably coupled to another network 742 by means of a communications link 750a. The gateway 746 may also be directly coupled to one or more workstations 711 using a communications link 750b, 750c, and/or may be indirectly coupled to such devices. The gateway computer 746 may be implemented utilizing an Enterprise Systems Architecture/390® computer available from IBM. Depending on the application, a midrange computer, such as an iSeries®, System i™, and so forth may be employed. (“Enterprise Systems Architecture/390” and “iSeries” are registered trademarks, and “System i” is a trademark, of IBM in the United States, other countries, or both.)

The gateway computer 746 may also be coupled 749 to a storage device (such as data repository 748).

Those skilled in the art will appreciate that the gateway computer 746 may be located a great geographic distance from the network 742, and similarly, the workstations 711 may be located some distance from the networks 742 and 744, respectively. For example, the network 742 may be located in California, while the gateway 746 may be located in Texas, and one or more of the workstations 711 may be located in Florida. The workstations 711 may connect to the wireless network 742 using a networking protocol such as the Transmission Control Protocol/Internet Protocol (“TCP/IP”) over a number of alternative connection media, such as cellular phone, radio frequency networks, satellite networks, etc. The wireless network 742 preferably connects to the gateway 746 using a network connection 750a such as TCP or User Datagram Protocol (“UDP”) over IP, X.25, Frame Relay, Integrated Services Digital Network (“ISDN”), Public Switched Telephone Network (“PSTN”), etc. The workstations 711 may connect directly to the gateway 746 using dial connections 750b or 750c. Further, the wireless network 742 and network 744 may connect to one or more other networks (not shown), in an analogous manner to that depicted in FIG. 7.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), DVD, an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute as a stand-alone software package, and may execute partly on a user's computing device and partly on a remote computer. The remote computer may be connected to the user's computing device through any type of network, including a local area network (“LAN”), a wide area network (“WAN”), or through the Internet using an Internet Service Provider.

Aspects of the present invention are described above with reference to flow diagrams and/or block diagrams of methods, apparatus (systems), and computer program products according to embodiments of the invention. It will be understood that each flow or block of the flow diagrams and/or block diagrams, and combinations of flows or blocks in the flow diagrams and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flow diagram flow or flows and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram flow or flows and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flow diagram flow or flows and/or block diagram block or blocks.

Flow diagrams and/or block diagrams presented in the figures herein illustrate the architecture, functionality, and operation of possible implementations of systems, methods, and computer program products according to various embodiments of the present invention. In this regard, each flow or block in the flow diagrams or block diagrams may represent a module, segment, or portion of code, which comprises one or more executable instructions for implementing the specified logical function(s). It should also be noted that, in some alternative implementations, the functions noted in the flows and/or blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flow of the flow diagrams, and combinations of blocks in the block diagrams and/or flows in the flow diagrams, may be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of tracking file-centric events, comprising:
invoking event tracking by an operating system of a computer at system start-up, the event tracking pertaining to events performed for files by applications executing on the computer;
responsive to occurrence of an event for a file, tracking the event by recording an event record in an event log for the computer, the event record comprising an identifier of the file, an identifier of the event, and an identifier of an application performing the event for the file; and
responsive to a request from a user to view events for the file, retrieving the event record and displaying the retrieved event record for the user.

2. The method according to claim 1, wherein the occurrence of the event is detected by the operating system when the application obtains a lock on the file.

3. The method according to claim 1, wherein the occurrence of the event is detected by the operating system when the application releases a lock on the file.

4. The method according to claim 1, wherein an application programming interface (“API”) for the event tracking is accessible to the applications executing on the computer, and the occurrence of the event is detected by the operating system when the application invokes the API.

5. The method according to claim 1, wherein the displaying further comprises presenting a selectable link for the event, the selectable link being operable to open the file using the application.

6. The method according to claim 1, wherein the event record for each of a plurality of events is recorded in the event log.

7. The method according to claim 1, wherein the event record further comprises a timestamp of the event.

8. The method according to claim 1, wherein the event record further comprises application-specific information pertaining to the event as performed by the application.

9. The method according to claim 1, wherein the event record further comprises related file information.

10. The method according to claim 1, wherein:
event records are recorded in the event log for each of a plurality of events for the file; and
the retrieving and displaying further comprise retrieving and displaying each of the plurality of event records for the file.

11. The method according to claim 1, wherein:
the event record further comprises related file information; and
the retrieving and displaying further comprise retrieving and displaying the related file information.

12. The method according to claim 1, wherein:
event records are recorded in the event log for each of a plurality of events for the file; and
the events comprise one or more of: opening the file; closing the file; creating the file, modifying the file; deleting the file; copying the file; sending the file; and uploading the file.

13. A system for tracking file-centric events, comprising:
a computer comprising a processor; and
instructions which are executable, using the processor, to implement functions comprising:
invoking event tracking by an operating system of a computer at system start-up, the event tracking pertaining to events performed for files by applications executing on the computer;
responsive to occurrence of an event for a file, tracking the event by recording an event record in an event log for the computer, the event record comprising an identifier of the file, an identifier of the event, and an identifier of an application performing the event for the file; and
responsive to a request from a user to view events for the file, retrieving the event record and displaying the retrieved event record for the user.

14. The system according to claim 13, wherein the occurrence of the event is detected by the operating system when the application obtains a lock on the file or when the application releases the lock on the file.

15. The system according to claim 13, wherein an application programming interface (“API”) for the event tracking is accessible to the applications executing on the computer, and the occurrence of the event is detected by the operating system when the application invokes the API.

16. The system according to claim 13, wherein the displaying further comprises presenting a selectable link for the event, the selectable link being operable to open the file using the application.

17. A computer program product for tracking file-centric events, the computer program product comprising:
a computer readable storage medium having computer readable program code embodied therein, the computer readable program code configured for:
invoking event tracking by an operating system of a computer at system start-up, the event tracking pertaining to events performed for files by applications executing on the computer;
responsive to occurrence of an event for a file, tracking the event by recording an event record in an event log for the computer, the event record comprising an identifier of the file, an identifier of the event, and an identifier of an application performing the event for the file; and
responsive to a request from a user to view events for the file, retrieving the event record and displaying the retrieved event record for the user.

18. The computer program product according to claim 17, wherein the occurrence of the event is detected by the operating system when the application obtains a lock on the file or when the application releases the lock on the file.

19. The computer program product according to claim 17, wherein an application programming interface (“API”) for the event tracking is accessible to the applications executing on the computer, and the occurrence of the event is detected by the operating system when the application invokes the API.

20. The computer program product according to claim 17, wherein the displaying further comprises presenting a selectable link for the event, the selectable link being operable to open the file using the application.
